(19) United States
(12) Patent Application Publication
(10) Pub. No.: US 2008/0205598 A1
(43) Pub. Date: Aug. 28, 2008

(54) Coherent Scatter Computer Tomography Material Identification

(75) Inventors: Udo Van Stevendaal, Ahrensburg (DE); Jens-Peter Schlomka, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/813,111

(22) PCT Filed: Jan. 10, 2006
(86) PCT No.: PCT/IB06/50095

§ 371 Date: Jun. 29, 2007

(30) Foreign Application Priority Data
Jan. 12, 2005 (GB) 0500536.8

(51) Int. Cl. G01N 23/201

(52) U.S. Cl. 378/88

(57) ABSTRACT

In a CSCT material identification apparatus CT-information and differential scatter cross-sections are used for material identification. According to an aspect of the present invention, a material identification is provided which uses both the differential and the total scatter cross-sections. This may yield an improved material discrimination, i.e. a better detection rate and a lower false alarm rate.

The present invention relates to the field of computer tomography, for example in baggage inspection. In particular, the present invention relates to a material identification apparatus for examination of an object of interest, to a method of examination of an object of interest in a material identification apparatus and to a computer program for performing an examination of an object of interest in a material identification apparatus.

Coherent Scatter (CS) Computer Tomography (CT) is a novel imaging method based on coherently scattered x-ray photons. A coherent scatter CT system is built of an x-ray tube, illuminating one slice of the object, and a detection system, both rotating around a patient or other object to be observed. The detection system may either be a two-dimensional detector, which measures the off-plane scattered photons, or a single-row detector, which performs an energy-resolved measurement of the scattered photons.

In a CSCT scanner, a narrow fan-beam with small divergence in the out-off fan-plane direction penetrates an object. One slice of the object is illuminated by the fan-beam and the transmitted radiation as well as the radiation scattered in the direction out-off the fan-plane is detected and reconstructed.

However, not all the information available is used for material or component discrimination.

Hence, there is a desire for an improved material discrimination.

In accordance with an exemplary embodiment of the present invention, the above desire may be met by a material identification apparatus for examination of an object of interest, the material identification apparatus comprising a radiation source emitting a beam of electromagnetic radiation to the object of interest, a radiation detector adapted for detecting radiation emitted from the radiation source and coherently scattered from the object of interest and a determination unit adapted for determining a total scatter cross-section of the object of interest and for comparing the total scatter cross-section of the object of interest with a library value, resulting in an identification result, wherein the library value is an entry corresponding to a total scatter cross-section of a model object.

Thus, a material identification apparatus is provided which determines the total scatter cross-section of the object of interest and performs a material identification on the basis of the determined total scatter cross-section.

Advantageously, this may lead to an improved material discrimination, since additional information is used for the identification of specific materials, i.e. the total scatter cross-section of the material. Therefore, a better detection rate and a lower false alarm rate may be provided.

According to another exemplary embodiment of the present invention, the total scatter cross-section of the object of interest is determined by a summing of a first differential coherent scatter cross-section of the object of interest and a second differential coherent scatter cross-section of the object of interest, wherein the first differential coherent scatter cross-section is detected by the radiation detector and corresponds to a first momentum-transfer and wherein the second differential coherent scatter cross-section is detected by the radiation detector and corresponds to a second momentum-transfer of scattered radiation.

Therefore, a quantity, which represents the total scatter cross-section is calculated by summing the differential coherent-scatter cross-sections along the momentum-transfer direction for the reconstructed CSCT image slices.

According to another exemplary embodiment of the present invention, the material identification apparatus is adapted for performing and reconstructing a computer tomography (CT) scan and for performing and reconstructing a coherent scatter computer tomography scan (CSCT).

Advantageously, this may provide a material identification apparatus for the simultaneous or subsequent measurement of coherently scattered x-rays and of the transmitted radiation. The combined CT and (total) scatter information may be used for material identification in the case of baggage inspection applications and in medical applications for the detection of diseases, which modify the molecular structure of tissue.

The invention may combine conventional CT with CSCT in a single apparatus.

According to another exemplary embodiment of the present invention, the library-function comprises a fourth entry corresponding to a total scatter cross-section of a model object, wherein the determination unit is further adapted for comparing the total scatter cross-section of the object of interest with the fourth entry of the library function, resulting in a fourth comparison result.

According to another exemplary embodiment of the present invention, the library-function further comprises a first entry corresponding to a first differential coherent scatter cross-section of the model object, a second entry corresponding to a second differential coherent scatter cross-section of the model object and a third entry corresponding to a transmission-CT image of the model object, wherein the determination unit is further adapted for comparing the first differential coherent scatter cross-section of the object of interest with the first entry, resulting in a first comparison result, comparing the second differential coherent scatter cross-section of the object of interest with the second entry, resulting in a second comparison result, and comparing the transmission-CT image of the object of interest with the third entry of the library-function, resulting in a third comparison result. The differential cross-section may be, for example, a function of the momentum transfer. If the cross-section is given at certain momentum transfer values, the function consists of discrete values. In this case, first and second differential cross-section means that the differential cross-section of a single object point consists of at least two discrete values at two different momentum transfers.

Advantageously, according to this exemplary embodiment of the present invention, the material identification system may use three different data sets for material identification, i.e. the differential coherent scatter cross-section, the total scatter cross-section and the transmission-CT image. Each of the three data sets is compared to a library-function, thus providing for an improved and fast material discrimination.

According to another exemplary embodiment of the present invention, the determination unit is further adapted for determining, on the basis of at least one of the first, second, third, and fourth comparison results, the identification result and triggering an alarm, if the identification result exceeds a predetermined threshold value.

Advantageously, by changing the predetermined threshold value, the sensitivity of the material discrimination may be tuned according to appropriate security standards by a user or automatically.

According to another exemplary embodiment of the present invention, comparing the first differential coherent scatter cross-section of the object of interest with the first entry and comparing the second differential coherent scatter cross-section of the object of interest with the second entry is performed by a cross-correlation analysis of a set of library functions.

According to another exemplary embodiment of the present invention, a peak detection of a measured differential coherent scatter cross section curve is performed, wherein the curve comprises the first differential coherent scatter cross section and the second differential coherent scatter cross section of the object of interest, and wherein a comparison of a width of the detected peak and a position of the detected peak with a fifth library entry and a sixth library entry is performed, resulting in a fifth comparison result, wherein the identification result is determined on the basis of the fifth comparison result.

According to another exemplary embodiment of the present invention, the source of electromagnetic radiation is a polychromatic x-ray source, wherein the source moves along a circular or helical path around the object of interest and wherein the beam has a fan-beam geometry.

The application of a polychromatic x-ray source may be advantageous, since polychromatic x-rays are easy to generate and provide a high photon flux.

The material identification system may be configured as one of the group consisting of a baggage inspection apparatus, a medical application apparatus, a material testing apparatus and a material science analysis apparatus. However, the most preferred field of application of the invention may be baggage inspection and medical applications, since the invention allows for an improvement of material discrimination.

The invention creates a high-quality automatic system that may automatically recognize certain types of materials and, if desired, trigger an alarm in the presence of dangerous materials.

According to another exemplary embodiment of the present invention, a method of examination of an object of interest in a material identification apparatus is disclosed, the method comprising the steps of emitting a beam of electromagnetic radiation from a source to an object of interest, detecting radiation emitted from the radiation source and coherently scattered from the object of interest by a radiation detector, determining a total scatter cross-section of the object of interest and comparing the total scatter cross-section of the object of interest with a library function, wherein the library function comprises an entry corresponding to a total scatter cross-section of a model object.

The present invention also relates to a computer program, which may, for example, be executed on a processor, such as an image processor. Such a computer program may be part of, for example, a CSCT scanner system. The computer program, according to an exemplary embodiment of the present invention, may preferably loaded into working memories of a data processor. The data processor may thus be equipped to carry out exemplary embodiments of the methods of the present invention. The computer program may be written in any suitable programming language, such as, for example, C++ and may be stored on a computer-readable medium, such as a CD-ROM. Also, the computer program may be available from a network, such as the WorldWideWeb, from which it may be downloaded into image processing units or processors, or any suitable computers.

An aspect of the present invention may be that both the differential and the total scatter cross-section is used for material discrimination. This may provide for an improved material discrimination, a better detection rate and a lower false alarm rate.

The aspects defined above and further aspects of the invention are apparent from the examples of embodiments to be described hereinafter and are explained with reference to these examples of embodiments.

Exemplary embodiments of the present invention will be described in the following, with reference to the following drawings:

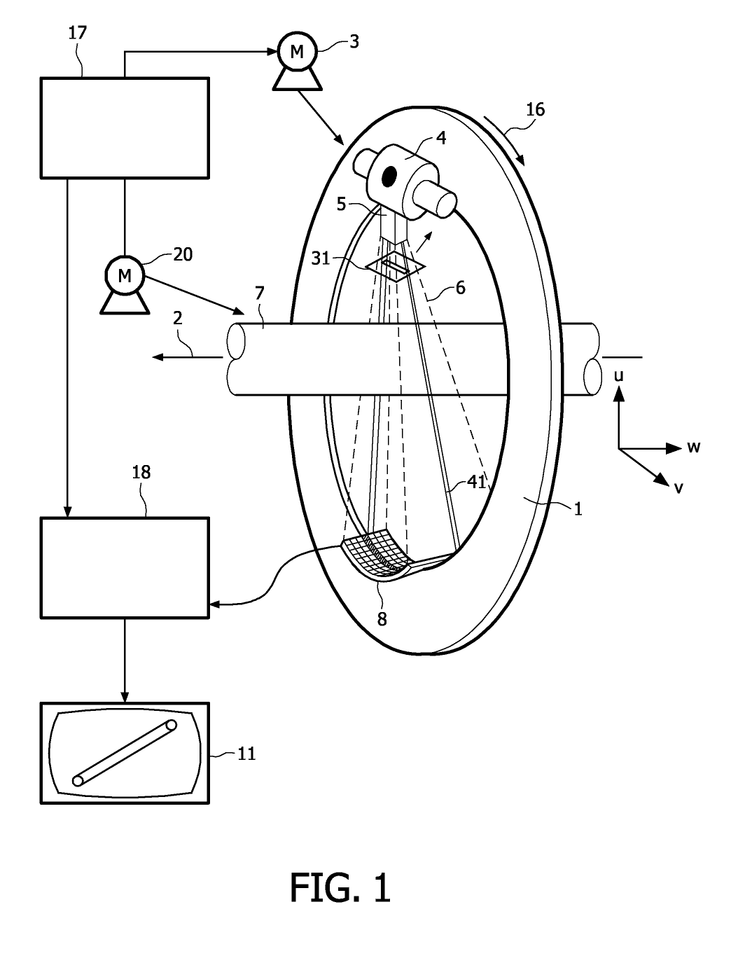

FIG. 1 shows a simplified schematic representation of an embodiment of a CSCT scanner according to the present invention.

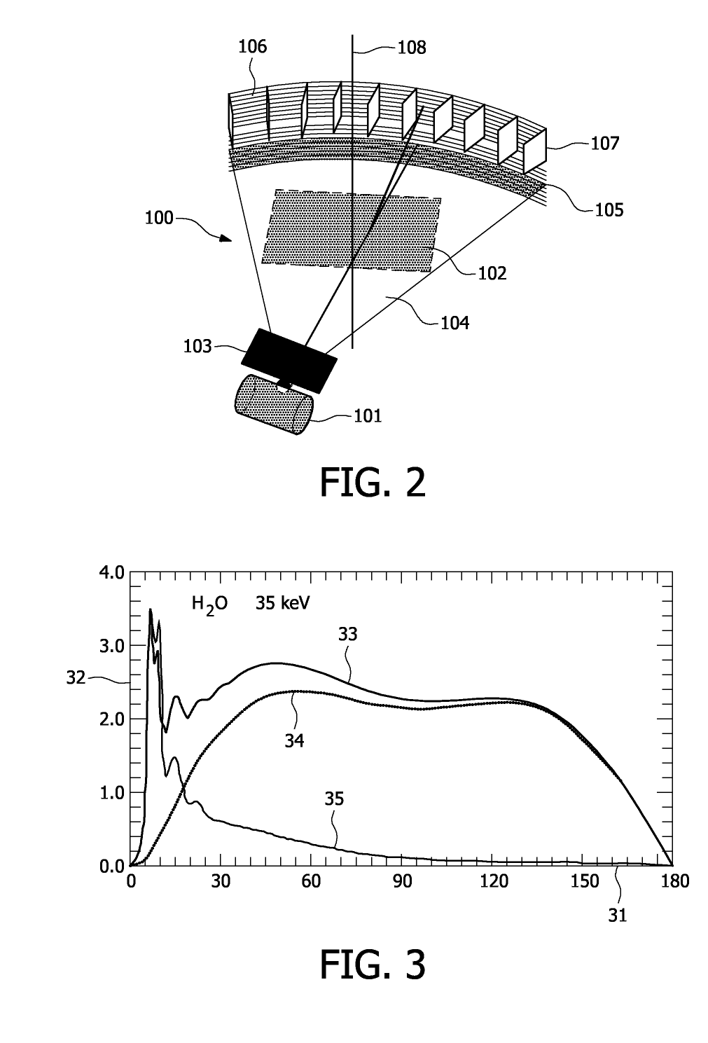

FIG. 2 shows a geometry for energy-resolved CSCT.

FIG. 3 shows a schematic representation of a coherent scattering cross-section, an incoherent scattering cross-section and the addition of both as the resulting scatter cross section.

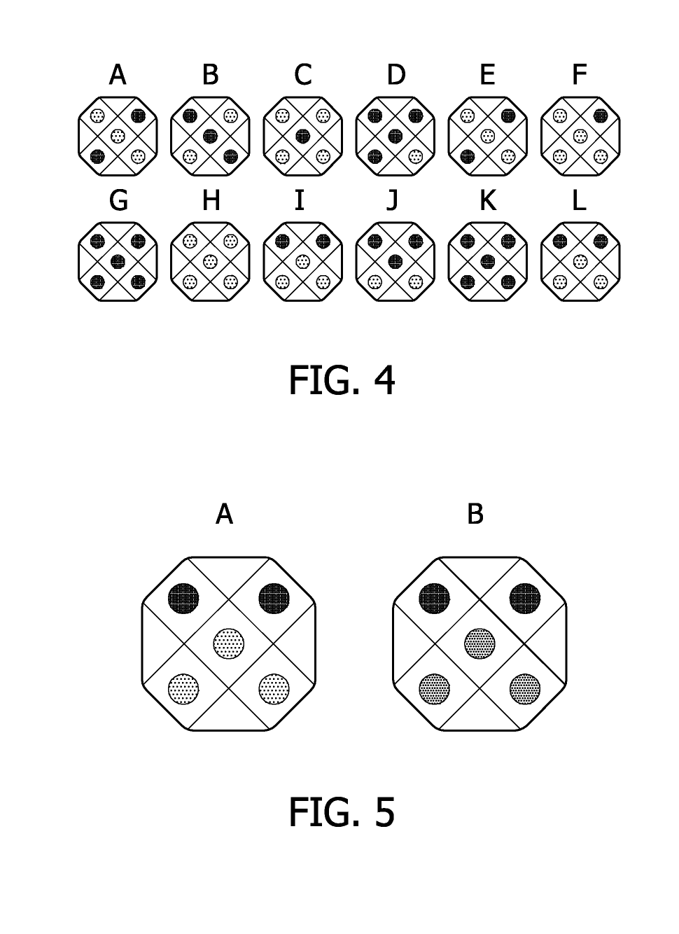

FIG. 4A-4L show schematic representations of reconstructed CSCT-slices of a phantom.

FIG. 5A shows a schematic representation of a total scatter cross-section image of an object.

FIG. 5B shows a schematic representation of a CT image of the object of FIG. 5a.

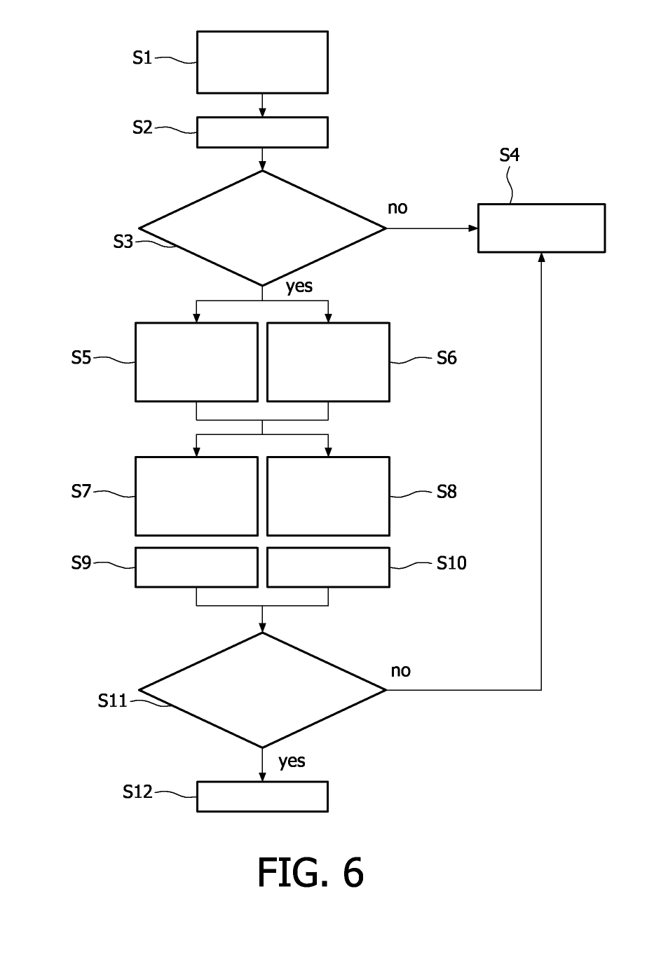

FIG. 6 shows a flow-chart of an exemplary embodiment of a method according to the present invention.

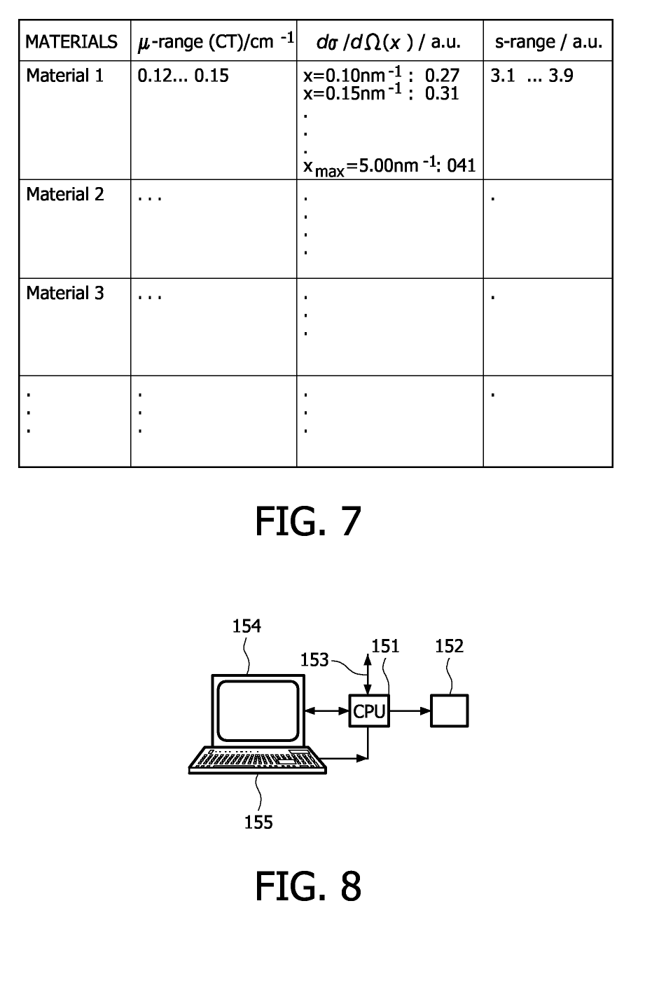

FIG. 7 shows exemplary library entries of a library-function according to an exemplary embodiment of the present invention.

FIG. 8 shows an exemplary embodiment of an image processing device according to the present invention for executing an exemplary embodiment of a method in accordance with the present invention.

The illustration in the drawings is schematically. In different drawings, similar or identical elements are provided with the same reference numerals.

With reference to this exemplary embodiment, the present invention will be described for the application in baggage inspection to detect hazardous materials, such as explosives, in items of baggage or other industrial applications. However, it should be noted that the present invention is not limited to the application in the field of baggage inspection, but may be used in applications such as medical imaging or other industrial applications, such as material testing.

The scanner depicted in FIG. 1 is a fan-beam CSCT scanner. The CSCT scanner depicted in FIG. 1 comprises a gantry 1, which is rotatable around a rotational axis 2. The gantry 1 is driven by means of a motor 3. Reference numeral 4 designates a source of radiation, such as an x-ray source, which, according to an aspect of the present invention, emits a polychromatic radiation beam.

Reference numeral 5 designates an aperture system which forms a radiation beam emitted from the radiation source 4 to a radiation beam 6. After emitting the radiation beam 6, the beam may be guided through a slit collimator 31 to form a primary fan-beam 41 impinging on an object 7 to be located in an object region.

The fan-beam 41 is now directed such that it penetrates the object of interest 7 arranged in the center of the gantry 1, i.e. in an examination region of the CSCT scanner and impinges onto the detector 8. As may be taken from FIG. 1, the detector 8 is arranged on the gantry 1 opposite the source of radiation 4, such that the surface of the detector 8 is covered by the fan-beam 41. The detector 8 depicted in FIG. 1 comprises a plurality of detector elements.

During a scan of the object of interest 7, the source of radiation 4, the aperture system 5 and detector 8 are rotated along the gantry 1 in the direction indicated by arrow 16. For rotation of the gantry 1 with the source of radiation 4, the aperture system 5 and the detector 8, the motor 3 is connected to a motor control unit 17, which is connected to a determination or determination unit 18.

During a scan, the radiation detector 8 is sampled at predetermined time intervals. Sampling results read from the radiation detector 8 are electrical signals, i.e. processed and represent radiation intensity, which may be referred to as projection in the following. A whole data set of a whole scan of an object of interest therefore consists of a plurality of projections where the number of projections corresponds to the time interval with which the radiation detector 8 is sampled. A plurality of projections together may also be referred to as volumetric data. Furthermore, the volumetric data may also comprise electrocardiogram data.

In FIG. 1, the object of interest is disposed on a conveyor belt 19. During the scan of the object of interest 7, while the gantry 1 rotates around the patient 7, the conveyor belt 19 displays the object of interest 7 along a direction parallel to the rotational axis 2 of the gantry 1. By this, the object of interest 7 is scanned along a helical scan path. The conveyor belt 19 may also be stopped during the scans. Instead of providing a conveyor belt 19, for example, in medical applications, where the object of interest 7 is a patient, a movable table may be used. However, it should be noted that in all of the described cases it is also possible to perform a circular scan, where there is no displacement in a direction parallel to the rotational axis 2, but only the rotation of the gantry 1 around the rotational axis 2.

The detector 8 is connected to the determination unit 18. The determination unit 18 receives the detection result, i.e. the read-outs from the detector element of the detector 8, and determines a scanning result on the basis of the read-outs. The detector elements of the detector 8 may be adapted to measure the attenuation caused to the fan-beam 6 by the object of interest 7 or the energy and intensity of x-rays coherently scattered from an object point of the object of interest 7 with an energy inside a certain energy interval. Furthermore, the determination unit 18 communicates with the motor control unit 17 in order to coordinate the movement of the gantry 1 with motor 3 and 20 or with a conveyor belt (not shown in FIG. 1).

The determination unit 18 may be adapted for reconstructing an image from read-outs of the detector 8. The image generated by the determination unit 18 may be output to a display 11.

The determination unit 18 which may be realized by a data processor may also be adapted to perform a determination of a total scatter cross-section of the object of interest and a comparison of the total scatter cross-section of the object of interest with a library value, wherein the library value comprises an entry corresponding to a total scatter cross-section of a model object.

Furthermore, as may be taken from FIG. 1, the determination unit 18 may be connected to a loudspeaker to, for example, automatically output an alarm.

FIG. 2 shows a geometry for energy-resolved CSCT. The CSCT computer tomography apparatus 100 for examination of an object of interest 102 comprises an x-ray source 101 which rotates around a rotational axis 108 and which produces, together with a fan-beam collimator 103, a collimated fan-beam 104 impinging on the object of interest 102.

Radiation scattered by the object of interest 102 impinges on a decentred CSCT-detector 106 with one dimensional scatter collimator 107. The central detector line 105 measures transmitted radiation of the primary fan-beam 104. The CSCT-detector 106 measures scattered radiation.

The central detector 105, which may be a single-line or a multi-line detector, detects the directly transmitted radiation. The detector placed offset 106 is energy-resolving and measures scattered radiation. However, for non-energy-resolved CSCT a two-dimensional CT-detector may be sufficient.

According to an aspect of the present invention, the combined CT and scatter information may be used for material identification in the case of baggage inspection applications and in medical applications for the detection of diseases, which modify the molecular structure of tissue.

FIG. 3 shows a schematic representation of a coherent scattering cross-section 35, an incoherent scattering cross-section 34 and as the result the addition of both scatter contributions 33. The cross-sections depicted in FIG. 2 are at 35 keV for x-ray scattering in H₂O at angle Θ into a ring of infinitesimal width dΘ. The horizontal axis 31 represents the scatter angle Θ and the vertical axis 32 represents the cross-section dσ/dΩ in units of 10⁻²⁴ cm²/molecule/radian.

The integrals of these curves are the total scatter cross-sections. As may be seen from FIG. 3, coherent scatter is dominantly forward directed and therefore the range between 0 and a few degrees is sufficient to cover most of the coherent scatter cross-section.

In the following, aspects of the present invention are described in greater detail:

Coherent-Scatter Computed Tomography (CSCT) is a reconstructive x-ray imaging technique that yields the spatially resolved Coherent-Scatter Cross-Section (CSCS) of the investigated object, i.e. for each object voxel with indices (i,j) in the measured slice a function dσ/dΩ(i,j,x) is reconstructed. Here, x is the momentum-transfer parameter given by

$$x = \frac{E}{hc} sin ( Θ / 2 ) , \qquad ( 1 )$$

where E is the energy of the photon, h Planck's constant, and c the speed of light.

The CSCS dσ/dΩ (x)=f(x) can be used to identify material by for example cross-correlation analysis with a set of library-functions g(x):

$$C ( x ) = \frac{\int f ( {x}^{′} ) g ( {x}^{′} - x ) d {x}^{′}}{\sqrt{\int {f ( {x}^{′} )}^{2} d {x}^{′}} \sqrt{\int {g ( {x}^{′} )}^{2} d {x}^{′}}} , \qquad ( 2 )$$

and C(0) can be used as a measure for the similarity of two functions since C(0)=1 is equivalent to f(x)=g(x).

When doing so, only the “shape” of the function is used for a similarity measure. For material or component discrimination it may be useful to determine the total cross-section, which describes the probability for scattering in any direction. A quantity s(i,j), which is similar to an image of the total cross-section may be calculated by summing the differential coherent scatter cross-section along the x-direction for the reconstructed CSCT image slices:

$$s ( i , j ) = {\sum }_{x} \frac{d σ ( i , j , x )}{d Ω} , \qquad ( 3 )$$

where s can only cover all reconstructed slices up to a maximum value xₘₐₓ given by the maximum measured scatter angle Θₘₐₓ (usually a few degrees) and the maximum energy in this spectrum Eₘₐₓ, which is limited by the acceleration voltage used in the x-ray tube (usually around 120-180 kV), by the application of equation (1). However, coherent scatter is dominantly forward directed, as may be seen from FIG. 3, and therefore the range is sufficient to cover most of the coherent scatter cross-section.

In other words, the resulting image s(i,j) describes the total scatter “strength” of the materials.

Furthermore, the CSCS may be used to identify a material by a “peak detection”, i.e. “peak positions” and “peak widths” from the measured curve are compared with values from the library.

An example how s (i,j) can add additional information is shown in FIGS. 4 and 5.

FIGS. 4A-4L show a set of images of reconstructed CSCT-slices (coherent-scatter cross-section or differential cross-section dσ/dΩ (i,j,x)), each taken at a different x-value. As may be seen from the images depicted in FIG. 4, each material exhibits distinct maximums at different x-values. This information may be used for material identification.

The images depicted in FIG. 4 show reconstructed CSCT-slices of a phantom containing plastic materials and aluminium for x=1.0 nm⁻¹ (FIG. 4A), x=1.2 nm⁻¹ (FIG. 4B), x=1.35 nm⁻¹ (FIG. 4C), x=1.6 nm⁻¹ (FIG. 4D), x=2.0 nm⁻¹ (FIG. 4E), x=2.1 nm⁻¹ (FIG. 4F), x=2.3 nm⁻¹ (FIG. 4G), x=2.45 nm⁻¹ (FIG. 4H), x=3.0 nm⁻¹ (FIG. 4I), x=3.6 nm⁻¹ (FIG. 4J), x=4.1 nm⁻¹ (FIG. 4K), x=4.5 nm⁻¹ (FIG. 4L).

FIG. 5A shows a schematic representation of a total scatter cross-section image s (i,j) of the plastic/aluminium object of FIG. 4. As may be seen from FIG. 5A, the total scatter cross-section image s (i,j) provides additional information which may be used for material discrimination.

FIG. 5B shows a schematic representation of a CT image μ (i,j) of the plastic/aluminium object of FIG. 4. Again, as may be seen from FIG. 5B, the CT image provides further information for material discrimination.

According to an aspect of the present invention, in a material identification algorithm all three data sets, which are represented by FIGS. 4 and 5, may be used for material identification by comparing each value with library-functions.

FIG. 6 shows a flow-chart of a material identification algorithm according to an aspect of the present invention. The method starts at step S1 with an acquisition of a projection data set. This may, for example, be performed by using a suitable CSCT scanner system or by reading the projection data from a storage. For example, in step S1, a CT-scan is performed and reconstructed. Then, in step S2, a corresponding transmission-CT image μ (i,j) is evaluated. If a suspicious region or suspicious regions are detected (on the basis of the performed evaluation), the method moves to steps S5 and S6. If, however, no suspicious region or suspicious regions are detected, the material identification apparatus moves to its next position in step S4.

In step S5, a CSCT scan is performed and reconstructed. At the same time, or before or after the performing and reconstructing of the CSCT scan, a list of possible threat materials is produced from a library in step S6. In step S7, the differential cross-sections dσ/dΩ (i,j,x) for suspicious regions are determined and in step S8, which may be performed at the same time, or before, or after, the total cross-sections s (i,j) for suspicious regions are determined.

In step S9, the differential cross-sections of step S7 are compared with values from a list (which is found in the library). Furthermore, in step S10, the total cross-sections of step S8 are compared with values from a list, which, again, is found in the library of step S6.

It should be noted, that the measurement of the CT- and CSCT-scan may be performed subsequently as depicted in FIG. 6, or in parallel. Also, the threat evaluation of step S11 may be performed subsequently or in parallel.

In step S11, it is determined whether the examined material has values of μ, dσ/dΩ(i,j,x) and s(i,j) corresponding to an hazardous material. This may, according to an exemplary embodiment of the present invention, be performed by determining, on the basis of the results of steps S3, S9 and S10, an identification result representing the affinity of the measured CT image (μ), the measured differential cross-section and the measured (and calculated) total cross-section to the entries of the library. If, in step S11, it is found that the material is similar to the model material (represented by the library entries), an alarm is triggered in step S12. If, however, no similarity is found, the apparatus moves to its next position in step S4.

FIG. 7 shows library entries of a library-function according to an exemplary embodiment of the present invention. As may be seen from FIG. 7, a plurality of different materials may be represented by the library entries, for example, material 1, material 2 and material 3. For each material the μ-range, the differential scatter cross-section dσ/dΩ (x) and the total scatter range s may be given. For example, for material 1, the μ-range is 0.12-0.15 cm⁻¹. Furthermore, the differential scatter cross-section for a momentum transfer x=0.10 nm⁻¹ is 0.27, for x=0.15 nm⁻¹ it is 0.13 and for xₘₐₓ=5.00 nm⁻¹ it is 0.41. The units are arbitrary.

Furthermore, the s-range for material 1 is, according to this exemplary embodiment of the present invention, 3.1-3.9, again in arbitrary units.

FIG. 8 depicts an exemplary embodiment of a data processing device according to the present invention for executing an exemplary embodiment of the method in accordance with the present invention. The data processing device depicted in FIG. 8 comprises a central processing unit (CPU) or image processor 151 connected to a memory 152 for storing an image depicting an object of interest. The data processor 151 may be connected to a plurality of input/output network or diagnosis devices, such as a CSCT apparatus. The data processor may furthermore be connected to a display device 154, for example, a computer monitor, for displaying information or an image computed or adapted in the data processor 151. An operator or user may interact with the data processor 151 via a keyboard 155 and/or other output devices, which are not depicted in FIG. 8.

Furthermore, via the bus system 153, it may also be possible to connect the image processing and control processor 151 to, for example, a motion monitor, which monitors a motion of the object of interest. In case, for example, a lung of a patient is imaged, the motion sensor may be an exhalation sensor. In case, the heart is imaged, the motion sensor may be an electrocardiogram.

It should be noted that the term “comprising” does not exclude other elements or steps and the “a” or “an” does not exclude a plurality and that a single processor or system may fulfil the functions of several means recited in the claims. Also elements described in association with different embodiments may be combined.

It should also be noted, that any reference signs in the claims shall not be construed as limiting the scope of the claims.

1. A material identification apparatus for examination of an object of interest, the material identification apparatus comprising:
a radiation source emitting a beam of electromagnetic radiation to the object of interest;
a radiation detector adapted for detecting radiation emitted from the radiation source and coherently scattered from the object of interest;
a determination unit adapted for determining a total scatter cross-section of the object of interest and for comparing the total scatter cross-section of the object of interest with a library value, resulting in an identification result;
wherein the library value is an entry corresponding to a total scatter cross-section of a model object.

2. The material identification apparatus of claim 1, wherein the total scatter cross-section of the object of interest is determined by a summing of a first differential coherent scatter cross-section of the object of interest and a second differential coherent scatter cross-section of the object of interest;
wherein the first differential coherent scatter cross-section is detected by the radiation detector and corresponds to a first momentum-transfer of scattered radiation; and
wherein the second differential coherent scatter cross-section is detected by the radiation detector and corresponds to a second momentum-transfer of scattered radiation.

3. The material identification apparatus of claim 1, being adapted for performing and reconstructing a computer tomography scan and being adapted for performing and reconstructing a coherent scatter computer tomography scan.

4. The material identification apparatus of claim 1, wherein a library-function comprises:
a fourth entry corresponding to a total scatter cross-section of the model object;
wherein the determination unit is further adapted for:
comparing the total scatter cross-section of the object of interest with the fourth entry of the library-function, resulting in a fourth comparison result.

5. The material identification apparatus of claim 4, wherein the library-function further comprises:
a first entry corresponding to a first differential coherent scatter cross-section of the model object;
a second entry corresponding to a second differential coherent scatter cross-section of the model object;
a third entry corresponding to a transmission-CT image of the model object;
wherein the determination unit is further adapted for:
comparing a transmission-CT image of the object of interest with the third entry of the library function, resulting in a third comparison result;
comparing the first differential coherent scatter cross-section of the object of interest with the first entry, resulting in a first comparison result; and
comparing the second differential coherent scatter cross-section of the object of interest with the second entry, resulting in a second comparison result.

6. The material identification apparatus of one of claim 4,
wherein the determination unit is further adapted for:
determining, on the basis of at least one of the first, second, third, and fourth comparison results, the identification result; and
triggering an alarm, if the identification result exceeds a predetermined threshold value.

7. The material identification apparatus of claim 5, wherein comparing the first differential coherent scatter cross-section of the object of interest with the first entry and comparing the second differential coherent scatter cross-section of the object of interest with the second entry is performed by a cross-correlation analysis of a set of library functions.

8. The material identification apparatus of claim 1, wherein a peak detection of a measured differential coherent scatter cross section curve is performed;
wherein the curve comprises the first differential coherent scatter cross section and the second differential coherent scatter cross section of the object of interest;
wherein a comparison of a width of the detected peak and a position of the detected peak with a fifth library entry and a sixth library entry is performed, resulting in a fifth comparison result; and
wherein the identification result is determined on the basis of the fifth comparison result.

9. The material identification apparatus of claim 1, wherein the source of electromagnetic radiation is a polychromatic x-ray source;
wherein the source moves along a helical path around the object of interest; and
wherein the beam has a fan-beam geometry.

10. The material identification apparatus of claim 1, configured as one of the group consisting of a baggage inspection apparatus, a medical application apparatus, a material testing apparatus and a material science analysis apparatus.

11. A method of examination of an object of interest in a material identification apparatus, the method comprising the steps of:
emitting a beam of electromagnetic radiation from a source of electromagnetic radiation to an object of interest;
detecting radiation emitted from the radiation source and scattered from the object of interest by a radiation detector;
determining a total scatter cross-section of the object of interest; and
comparing the total scatter cross-section of the object of interest with a library value;
wherein the library value is an entry corresponding to a total scatter cross-section of a model object.

12. A computer program for performing an examination of an object of interest in a material identification apparatus, wherein the computer program causes a processor to perform the following operation when the computer program is executed on the processor:
loading a data set acquired by means of a source of electromagnetic radiation emitting a beam of electromagnetic radiation to an object of interest, coherently scattered from the object of interest and detected by a radiation detector;
determining a total scatter cross-section of the object of interest; and
comparing the total scatter cross-section of the object of interest with a library value;
wherein the library value is an entry corresponding to a total scatter cross-section of a model object.
